(19) United States
(12) Patent Application Publication
(10) Pub. No.: US 2007/0049704 A1
(43) Pub. Date: Mar. 1, 2007

(54) Composition of high-frequency adhesive footwear sheet

(76) Inventor: Hee-Dae Park, Yonje-Gu (KR)

Correspondence Address: HYUN JONG PARK, 41 WHITE BIRCH ROAD, REDDING, CT, 06896-2209, US

(21) Appl. No.: 11/215,252

(22) Filed: Aug. 30, 2005

(51) Int. Cl. C08L 75/00; C08L 67/03

(52) U.S. Cl. 525/454

(57) ABSTRACT

The present invention provides a composition of a high-frequency adhesive footwear sheet containing aromatic ester-based resin having almost the same refractive index as thermoplastic polyurethane (TPU), thereby concurrently securing transparency, adhesiveness and cutting for the TPU sheet that is mainly made of ester-based polyol and aromatic isocyanate.

### BACKGROUND OF THE INVENTION

1. Field of the Invention

The present invention relates generally to a sheet adhered to a footwear upper, and in particular, to a composition of a high-frequency adhesive footwear sheet with adhesiveness, transparency and cutting improved.

2. Description of the Related Art

In a general manufacture of a footwear upper, two or more pieces of fabrics are selectively cut and integrally sewn, and a natural or artificial leather sheet or a synthetic resin sheet is printed in various types and stitched to the integrally sewn fabrics for decoration.

However, the footwear upper has a disadvantage in that a skilled worker and a high technology for sewing are not only required due to a long sewing time and an elaborate design, but also a product price is increased due to worker's high wage and long-time work, thereby losing external competitiveness.

In order to overcome the above disadvantage, in a conventional art, a printed polyvinyl chloride (Hereinafter, referred to as “PVC”) sheet is adhered to a footwear upper using a high-frequency heating method. The conventional PVC sheet has excellent adhesiveness and cutting, but, due to its environmental problem, is in a trend of gradual exclusion.

Accordingly, at present, various polymer materials are being substituted for the conventional PVC sheet having a critical influence on environmental contamination. Among them, thermoplastic polyurethane (Hereinafter, referred to as “TPU”) having almost the same physical property as the PVC is used to manufacture a TPU sheet.

However, the TPU sheet has a disadvantage in that it is not well cut due to its high toughness of resin, and distinctly reduces an adhesive strength to a specific substrate material (for example, woven textile fabrics).

At present, through several attempts, the TPU sheet has been a little improved in cutting, but has a drawback in that the adhesive strength to the substrate material is not improved and is rather weaken.

### SUMMARY OF THE INVENTION

It is, therefore, an object of the present invention to provide a composition of a high-frequency adhesive footwear sheet in which a thermoplastic polyurethane (TPU) sheet is improved in adhesiveness, transparency and cutting when a high-frequency work is performed.

It is another object of the present invention to provide a composition of a high-frequency adhesive footwear sheet in which a TPU sheet is improved in cutting without having influence on adhesiveness and transparency.

It is a further object of the present invention to provide a composition of a high-frequency adhesive footwear sheet in which a high-frequency work time is reduced and a process cost is reduced.

To achieve the above and other objects, there is provided a composition of a high-frequency adhesive footwear sheet, which is primarily made of TPU (thermoplastic polyurethane) and is adhered to a footwear upper in a high-frequency work, wherein the composition contains aromatic ester-based resin.

### DETAILED DESCRIPTION OF PREFERRED EMBODIMENT

Preferred embodiments of the present invention will now be described in detail. However, various modifications and variations can be made in the embodiments of the present invention. Preferably, a compounding ratio of a composition is limited to provide the best effect in each of the below embodiments and therefore, the present invention should not be construed to be limited in scope to the below embodiments. The embodiments are provided to more distinctly illustrate the present invention for those having an ordinary skill in the art.

In the present invention, first of all, a thermoplastic polyurethane (TPU) sheet was manufactured by blending TPU with resin having a lower melt viscosity than the TPU to improve the TPU sheet in cutting. The resin was selected from the group consisting of acrylic base, ethylene-vinyl acetate, styrene-butadiene-styrene base and rubber base, to have no great influence on adhesiveness or transparency of the TPU sheet. As a result, the cutting was improved, but the adhesiveness and the transparency were a little degraded.

Accordingly, in the present invention, a TPU sheet was manufactured by blending TPU with resin having almost the same refractive index as the TPU, preferably, with aromatic ester-based resin, in order to concurrently secure the transparency, the adhesiveness and the cutting for the TPU sheet that is mainly made of ester-based polyol and aromatic isocyanate.

In other words, a high-frequency adhesive footwear sheet was manufactured by blending a 10 to 40 weight % condensation polymer of bivalent aromatic acid and bivalent low-molecular weight alcohol, TPU of 60 to 90 weight %, an anti-yellowing agent of 0.5 to 3.0 weight %, and other additives of 0.5 to 3.0 weight %.

As the bivalent aromatic acid, a composition is used such as Terephthalic acid, Isophthalic acid, Adipic acid, and Phthalic anhydride.

As the bivalent low-molecular weight alcohol, a composition is used such as Ethylene glycol, Propylene glycol, Butylenes glycol, and Neopentyl glycol.

Meantime, the aromatic ester-based resin (that is, the condensation polymer of the bivalent aromatic acid and the bivalent low-molecular weight alcohol) was manufactured on the basis of the composition and the compounding ratio shown in Table 1 below. In Table 1, the composition and the compounding ratio are merely provided as one example, and are not intended to limit a scope of the present invention.

TABLE 1

| Composition | Compounding ratio (weight %) |
|---|---|
| Terephthalic acid | 10 to 20 |
| Isophthalic acid | 15 to 25 |
| Adipic acid | 15 to 25 |
| Phthalic anhydride | 5 to 15 |
| Neopentyl glycol | 40 to 50 |

Hereinafter, the preferred embodiments of the present invention will be in detail described, but are not intended to limit the present invention.

### First Embodiment

The TPU sheet was manufactured by compounding TPU having a hardness of 85A, the aromatic ester-based resin, an ultraviolet stabilizer, and a dusting agent in a ratio of 85.0:15.0:1.0:0.05.

### Second Embodiment

The TPU sheet was manufactured by compounding TPU having a hardness of 85A, the aromatic ester-based resin, pigment, an ultraviolet stabilizer, and a dusting agent in a ratio of 75.0:25.0:1.0:1.0:0.05.

### Third Embodiment

The TPU sheet was manufactured by compounding TPU having a hardness of 90A, the aromatic ester-based resin, an ultraviolet stabilizer, and a dusting agent in a ratio of 75.0:25.0:1.0:0.05.

As a result, the inventive TPU sheet has an excellent cutting and, particularly, has greatly improved transparency and adhesiveness in comparison to a conventional TPU sheet.

In other words, the inventive TPU sheet (preferably, the TPU sheet made of the condensation polymer of the bivalent aromatic acid and the bivalent low-molecular weight alcohol) can be printed with aqueous print ink owing to its excellent ink adhesiveness. The inventive TPU sheet has an excellent adhesive strength even to a mesh material in comparison to the conventional TPU sheet having a very poor adhesive strength to the mesh material. In particular, in the inventive TPU sheet, work time is greatly reduced, and the adhesive strength to an adherend is excellent in comparison to the conventional TPU sheet.

As described above, the present invention has an advantage in that the adhesiveness to a substrate material (footwear upper) is not only excellent at a room temperature, but also the cutting is improved, thereby greatly reducing a high-frequency process time and accordingly, reducing a process in number and cost when a footwear is manufactured.

Further, the present invention has an effect in that the TPU and the aromatic ester-based resin are blended, thereby improving the cutting of the TPU sheet in a high-frequency process and enhancing the adhesiveness between the TPU sheet and the footwear upper and, particularly, maintaining the transparency of the TPU sheet.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A composition of a high-frequency adhesive footwear sheet, which is primarily made of TPU (thermoplastic polyurethane) and is adhered to a footwear upper in a high-frequency work,
wherein the composition contains aromatic ester-based resin.

2. The composition of claim 1, wherein the aromatic ester-based resin is a condensation polymer of bivalent aromatic acid and bivalent low-molecular weight alcohol.

3. The composition of claim 2, wherein the bivalent aromatic acid is selected from the group consisting of Terephthalic acid, Isophthalic acid, Adipic acid, and Phthalic anhydride.

4. The composition of claim 2, wherein the bivalent low-molecular weight alcohol is selected from the group consisting of Ethylene glycol, Propylene glycol, Butylenes glycol, and Neopentyl glycol.
